(19) United States
(12) Patent Application Publication
(10) Pub. No.: US 2005/0021562 A1
(43) Pub. Date: Jan. 27, 2005

(54) Management server for assigning storage areas to server, storage apparatus system and program

(75) Inventors: Hideomi Idei, Yokohama (JP); Norifumi Nishikawa, Machida (JP); Kazuhiko Mogi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/656,096

(22) Filed: Sep. 5, 2003

(30) Foreign Application Priority Data
Jul. 11, 2003 (JP) 2003-195451

(51) Int. Cl. G06F 7/00; G06F 17/00

(52) U.S. Cl. 707/104.1

(57) ABSTRACT

Even when an assignment request of storage areas exceeding unassigned areas is issued from a server, storage areas can be assigned to the server, so that storage areas in a storage pool can be utilized effectively. A management server connected to a plurality of servers and storage apparatuses to manage physical storage areas of the storage apparatuses used by the plurality of servers as virtual areas (storage pool) is responsive to an area assignment instruction of storage areas exceeding unassigned areas received from a server to release at least part of assignment areas of other servers to be assigned to the server which issued the area assignment instruction.

### BACKGROUND OF THE INVENTION

The present invention relates to a system including a management server which manages storage areas of storage apparatuses as virtual storage areas.

Recently, an amount of data stored in a storage apparatus is remarkably increased and the storage capacity of the storage apparatus and the number of storage apparatuses connected to the storage area network (SAN) are increased due to the increased amount of data. Consequently, there appear various problems such as complication in management of storage areas having the increased capacity, a concentrated load on the storage apparatus and an increased cost thereof. In order to solve these problems, the technique named virtualization is being studied and developed currently.

The virtualization technique is described in white paper “Virtualization of Disk Storage” (WP-0007-1), pp. 1-12, issued by Evaluator Group, Inc. in September 2000. According to the virtualization technique, a management server connected to storage apparatuses and servers using the storage apparatuses manages storage areas of the storage apparatuses connected to the SAN as virtual storage areas (storage pool) collectively and receives requests from the servers to the storage apparatuses. The management server accesses to the storage areas of the storage apparatuses connected thereunder in response to the requests from the servers and returns its results to the servers. Further, according to another virtualization technique, a management server connected to storage apparatuses and servers using the storage apparatuses manages storage areas of the storage apparatuses connected to the SAN as virtual storage areas collectively and when the management server receives a request from the server to the storage apparatus, the management server returns position information of the storage area in which data is actually stored to the server. The server accesses to the storage area of the storage apparatus on the basis of the position information returned from the management server.

### SUMMARY OF THE INVENTION

In the system configuration using the virtualization technique, it is considered that the servers secure lots of storage areas to provide for the future and write data in the secured storage area each time the necessity of writing data occurs. In this case, the storage area which is assigned to a certain server but in which data is not written probably exists in the storage apparatus. However, when the management server receives from another sever an assignment request of a storage area exceeding an unassigned area which is not yet assigned to any server, the management server cannot assign the storage area to the server in spite of the fact that unused area exists in the storage area and must increase the whole capacity of the storage areas in order to assign the requested storage area newly. Further, the storage area cannot be assigned to other servers until the whole capacity of the storage areas is increased.

Accordingly, it is an object of the present invention to assign a storage area to a server even when an assignment request of storage areas exceeding unassigned areas is issued from the server. Further, it is another object of the present invention to provide technique capable of utilizing storage areas in a storage pool effectively.

In order to solve the above objects, according to the present invention, a management server connected to a plurality of servers to manage storage areas included in storage apparatuses as virtual storage areas is responsive to an area assignment instruction of storage areas exceeding unassigned areas received from a server to release at least part of assignment areas of other servers as unassigned areas and assign the released storage areas to the server transmitting the area assignment instruction.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating an example of a computer system to which the present invention is applied;

FIG. 2 is a diagram showing an example of mapping information 112;

FIG. 3A is a diagram showing an example of storage pool management information 114;

FIG. 3B is a diagram showing an example of storage pool state information 116;

FIG. 4A is a diagram showing an example of an area assignment instruction 400 issued to a management server 100 by a server 130;

FIG. 4B is a diagram showing an example of an data write instruction 400 issued to a management server 100 by a server 130;

FIG. 4C is a diagram showing an example of an area release instruction 400 issued to a management server 100 by a server 130;

FIG. 4D is a diagram showing an example of an area return instruction 400 issued to a management server 100 by a server 130;

FIG. 5 is a flow chart showing an example of processing of an idle routine of a storage management program 110;

FIG. 6 is a flow chart showing an example of area assignment processing 502;

FIG. 7 is a flow chart showing an example of area return processing 606;

FIG. 8 is a flow chart showing an example of data writing processing 506;

FIG. 9 is a flow chart showing an example of area release processing 510 and billing processing 514;

FIG. 10 is a flow chart showing an example of billing processing 514; and

FIG. 11 is a diagram illustrating another example of a computer system to which the present invention is applied.

### DESCRIPTION OF THE EMBODIMENTS

An embodiment of the present invention is now described with reference to the accompanying drawings. However, the present invention is not limited thereto.

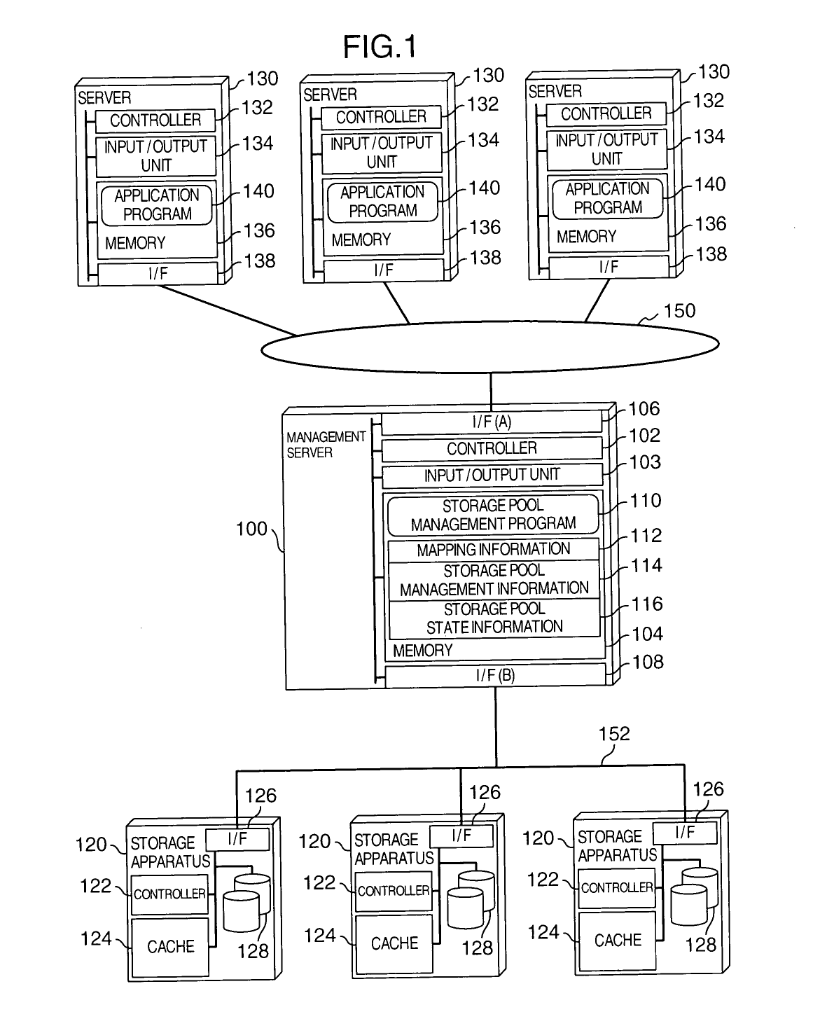

FIG. 1 is a diagram illustrating an example of a computer system to which the present invention is applied.

In the computer system of FIG. 1, servers 130 are connected to storage apparatuses 120 through a management server 100. The servers 130 and the management server 100 are connected through a network 150 to each other and the management server 100 and the storage apparatuses are connected through a network 152 to each other.

The server 130 includes a controller 132, an input/output unit 134, a memory 136 and an interface 138 for connecting the network 150. An application program 140 stored in the memory 140 is operated on the controller 132.

The management server 130 includes a controller 102, an input/output unit 103, a memory 104, an interface 106 for connecting the network 150 and an interface 108 for connecting the network 152.

A storage management program 110, mapping information 112, storage pool management information 114 and storage pool state information 116 are stored in the memory 104.

The storage pool management program 110 is a program operating on the controller 102 and manages physical storage areas of the storage apparatuses 120 as virtual data storage areas (storage pool) using the mapping information 112, the storage pool management information 114 and the storage pool state information 116. Further, the controller 102 executes the program to thereby make assignment of data areas, writing of data and release of data areas in response to requests from the servers 130. Moreover, when unassigned areas in the storage pool are insufficient and areas required by the server 130 cannot be assigned, the controller executes the storage pool management program 110 to issue a return request of areas to the server 130 having unused areas (data is not stored) in the areas assigned thereto or the server 130 to which storage areas in which data having low priority is stored are assigned so as to secure unassigned areas. Concrete processing contents of the program are described later in accordance with a processing flow.

The storage apparatus 120 includes a controller (control processor) 122, a cache 124, an interface 126 for connecting the network 152 and a disk unit 128 and the controller 122 controls the cache 124, the disk unit 128 and the like.

Three servers 130 and three storage apparatuses 120 are shown in FIG. 1, although the numbers thereof are not limited thereto and may be any number.

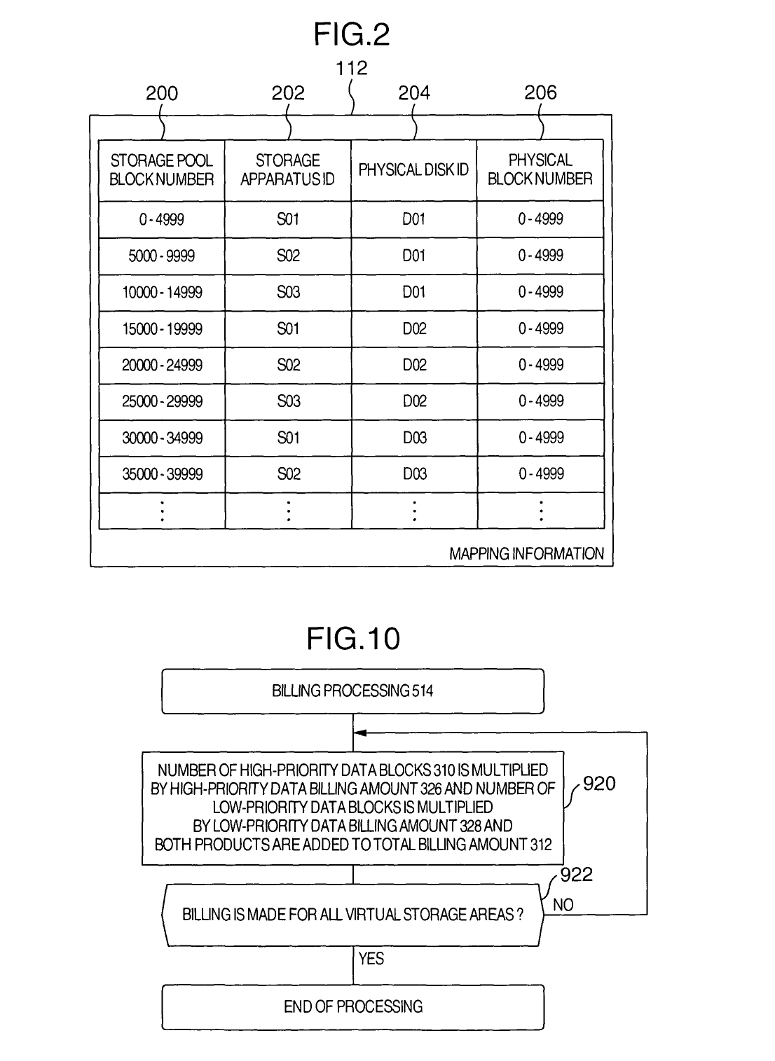

FIG. 2 is a diagram showing an example of the mapping information 112. The mapping information 112 includes storage pool block number 200, storage apparatus ID 202, physical disk ID 204 and physical block number 206.

The storage pool block number 200 indicates a block position in the storage pool. The storage apparatus ID 202 is an identifier of the storage apparatus 120 in which data in the block indicated by the storage pool block number 200 is stored actually. The physical disk ID 204 is an identifier of the physical disk unit 128 in the storage apparatus 120. The physical block number 206 is a number indicating a physical block in the physical disk unit 128.

When the first entry of the mapping information 112 is taken as an example, the storage pool blocks of block numbers 0 to 4999 actually exist in the physical blocks of block numbers 0 to 4999 in the physical disk unit 128 identified by “D01” in the storage apparatus 120 identified by “S01”.

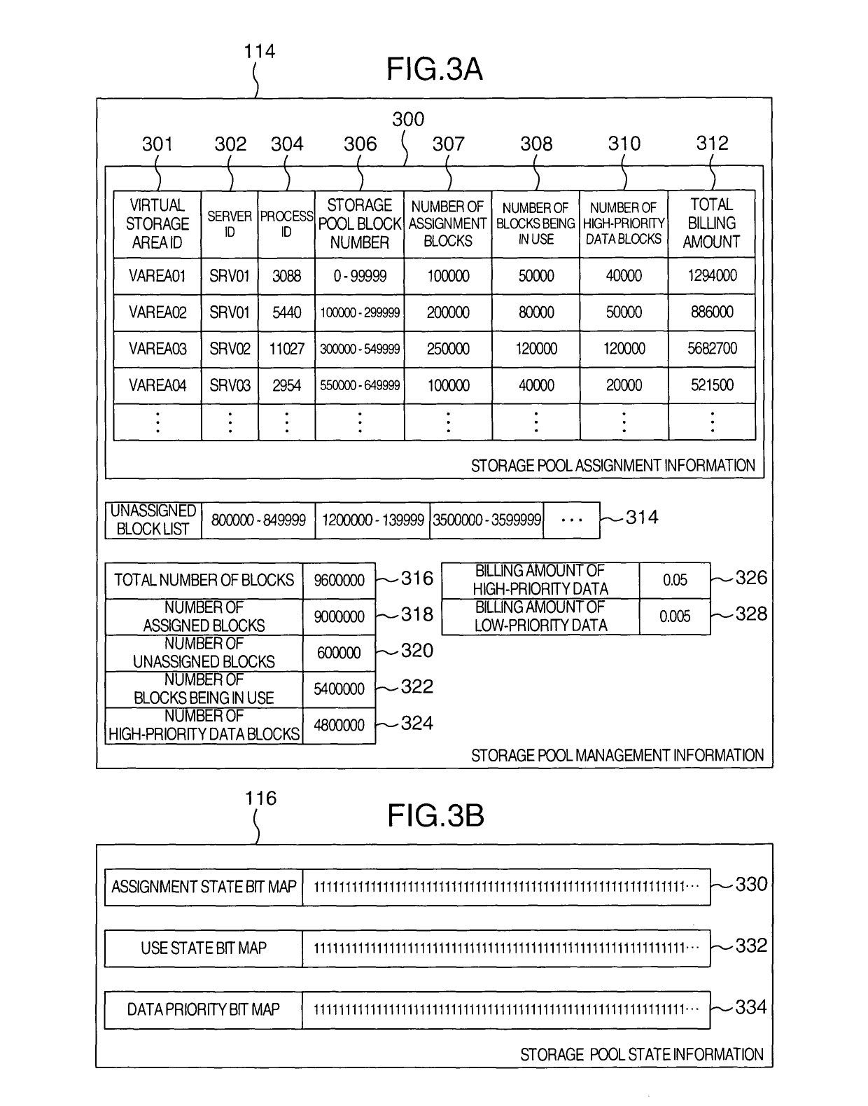

FIGS. 3A and 3B are diagrams showing examples of the storage pool management information 114 and the storage pool state information 116, respectively.

The storage pool management information 114 includes storage pool assignment information 300, unassigned block list 314, total number of blocks 316, number of assigned blocks 318, number of unassigned blocks 320, number of blocks being in use 322, number of high-priority data blocks 324, billing amount of high-priority data 326 and billing amount of low-priority data 328.

The storage pool assignment information 300 includes virtual storage area ID 301, server ID 302, process ID 304, storage pool block number 306, number of assignment blocks 307, number of blocks being in use 308, number of high-priority data blocks 310 and total billing amount 312.

The virtual storage area ID 301 is an ID for identifying an area in the storage pool-which is assigned to a server 130. The server ID 302 is an ID for identifying a server 130 to which the area identified by the virtual storage area ID 301 is assigned. The process ID 304 is an ID for identifying process in the server 130. The storage pool block number 306 is a block number in the storage pool assigned to the area identified by the virtual storage area ID 301. The number of assignment blocks 307 is the number of blocks being assigned. The number of blocks being in use 308 is the number of blocks in which data is already stored. The number of high-priority data blocks 310 is the number of blocks in which high-priority data is stored. The total billing amount 312 is the sum total of billing amounts at that time.

In the embodiment, the storage pool assignment information 300 keeps information of the number of blocks being in use 308 and the number of high-priority data blocks 310, while the storage pool assignment information 300 may keep information of the number of unused blocks and the number of low-priority data blocks.

When the first entry of the storage pool assignment information 300 is taken as an example, the area identified by “VAREA01” of the virtual storage area ID 301 is storage pool blocks of block numbers 0 to 99999 and is assigned to the process indicated by “3088” of the process ID 304 in the server identified by “SRV01” of the server ID 302. Further, the number of assignment blocks is “100,000” and the number of blocks being in use currently (in which data is stored) of the assignment blocks is 50,000, the number of blocks in which high-priority data is stored being 40,000. The sum total of billing amounts at that time is “1,294,000”.

The unassigned block list 314 is list information of blocks which are not assigned to the server 130. When the management server receives an area assignment request from the server 130, the management server extracts an area of required size from the unassigned block list and assigns it. The total number of blocks 316 is the number of all blocks in the storage pool and the number of assigned blocks 318 of the total number is the number of blocks assigned to the servers 130. The number of unassigned blocks 320 is the number of blocks which are not assigned to the server 130 and the number of blocks being in use is the number of blocks which are assigned to the servers 130 and in which data is stored. The number of high-priority data blocks 324 is the number of blocks in which high-priority data is stored. The billing amount of high-priority data 326 is a billing amount for blocks in which high-priority data is stored and the billing amount of low-priority data 328 is the billing amount for block in which low-priority data is stored. The management server 100 defines these billing amounts as the billing unit to make billing on the basis of the number of blocks for high-priority data and low-priority data for each virtual storage area ID and calculates the billing amounts for each time.

In the embodiment, the storage pool management information 114 keeps information of the number of blocks being in use 322 and the number of high-priority data blocks, while the storage pool management information 114 may keep information of the number of unused blocks and the number of low-priority data blocks.

The storage pool state information 116 includes an assignment state bit map 330, a use state bit map 332 and a data priority bit map 334. Bits of these bit maps correspond to blocks of the storage pool in one-to-one correspondence manner and indicate states of the blocks. The assignment state bit map 330 indicates assignment states of the blocks of the storage pool and when a bit is “0”, the block corresponding to the bit is in an unassigned state and when a bit is “1”, the block corresponding to the bit is in an assigned state. The use state bit map 332 indicates use states of the blocks of the storage pool and when a bit is “0”, the block corresponding to the bit is in an unused state (data is not stored) and when a bit is “1”, the block corresponding to the bit is in a used state (data is stored). The data priority bit map 334 indicates priorities of data stored in the blocks of the storage pool and when a bit is “0”, data of low priority is stored in the block corresponding to the bit and when a bit is “1”, data of high priority is stored in the block corresponding to the bit.

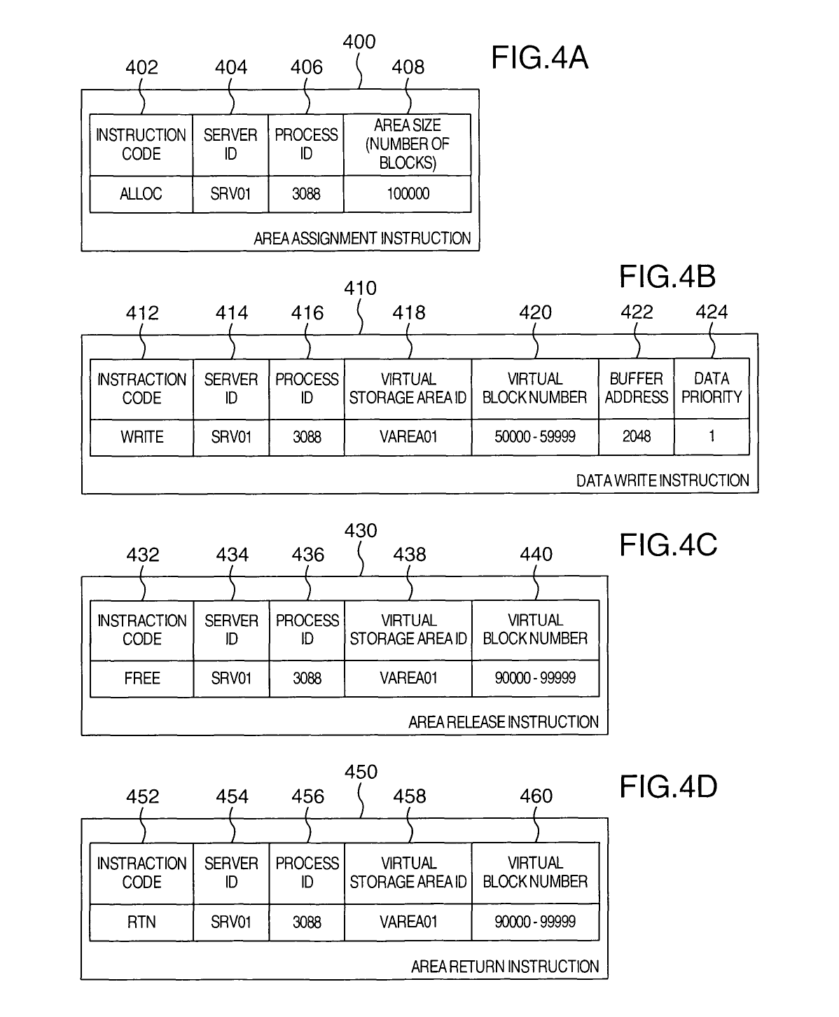

FIGS. 4A, 4B, 4C and 4D show examples of an area assignment instruction 400 issued to the management server 100 when the server 130 secures a data area on the storage pool, a data write instruction 410 issued to the management server 100 by the server 130 when data is written in the secured data area on the storage pool, an area release instruction 430 issued by the server 130 when the secured data area on the storage pool is released and an area return instruction 450 issued to the server 130 in order that the management server 100 produces an unassigned area, respectively.

The area assignment instruction 400 includes an instruction code 402, a server ID 404, a process ID 406 and an area size 408.

When the server 130 issues the area assignment instruction 400, the server 130 stores a code indicating that the instruction is the area assignment instruction, an ID of its own server, an ID of its own process and a size of the area to be secured into the instruction code 402, the server ID 404, the process ID 406 and the area size 408, respectively. Further, in the embodiment, the number of blocks is used as the size of the area to be secured.

The data write instruction 410 includes an instruction code 412, a server ID 414, a process ID 416, a virtual storage area ID 418, a virtual block number 420, a buffer address 422 and a data priority 424.

When the server 130 issues the data write instruction 410, the server 130 stores a code indicating that the instruction is the data write instruction, an ID of its own server, an ID of its own process, an ID indicating an area in which data is to be written, a virtual block number indicating a block in which data is to be written, an address of a buffer having data to be written and a priority of data to be written in the instruction code 412, the server ID 414, the process ID 416, the virtual storage area ID 418, the virtual block number 420, the buffer address 422 and the data priority 424 of the data write instruction 410, respectively. Further, in the embodiment, it is supposed that “0” is stored in the data priority 424 for the low-priority data and “1” is stored in the data priority 424 for the high-priority data.

The area release instruction 430 includes an instruction code 432, a server ID 434, a process ID 436, a virtual storage area ID 438 and a virtual block number 440.

When the server 130 issues the area release instruction 430, the server 130 stores a code indicating the instruction is the area release instruction, an ID of Its own server, an ID of its own process, an ID indicating an area to be released and a virtual block number indicating a block to be released in the instruction code 432, the server ID 434, the process ID 436, the virtual storage area ID 438 and the virtual block number 440 of the area release instruction 430, respectively.

The area return instruction 450 includes an instruction code 452, a server ID 454, a process ID 456, a virtual storage area ID 458 and a virtual block number 460.

When the management server 100 issues the area return instruction 450, the management server 100 stores a code indicating that the instruction is the area return instruction, an ID of the server 130 to which an area to be returned is assigned and an ID of the process, an ID indicating the area to be returned and a virtual block number indicating a block to be returned in the instruction code 452, the server ID 454, the process ID 456, the virtual storage area ID 458 and the virtual block number 460 of the area return instruction 450, respectively. The server 130 which has received the area return instruction 450 issues a release request of the designated area to the management server 100.

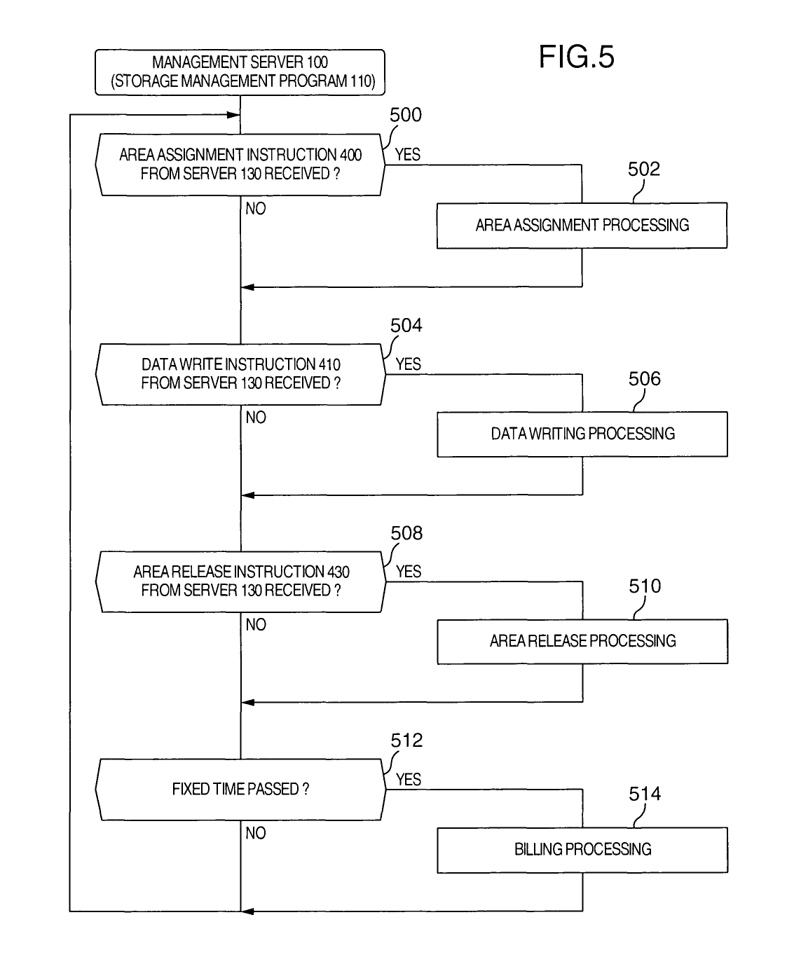

FIG. 5 is a flow chart showing an example of processing of an idle routine of the storage management program 110.

In processing 500, when the management server 100 judges that the area assignment instruction 400 is received from the server 130, the management server 100 executes area assignment processing 502.

In processing 504, when the management server 100 judges that the data write instruction 410 is received from the server 130, the management server 100 executes data writing processing 506.

In processing 508, when the management server 100 judges that the area release instruction 430 is received from the server 130, the management server 100 executes area release processing 510.

In processing 512, when the management server 100 judges that a fixed time passes from the time that the last billing processing was executed, the management server 100 executes billing processing 514.

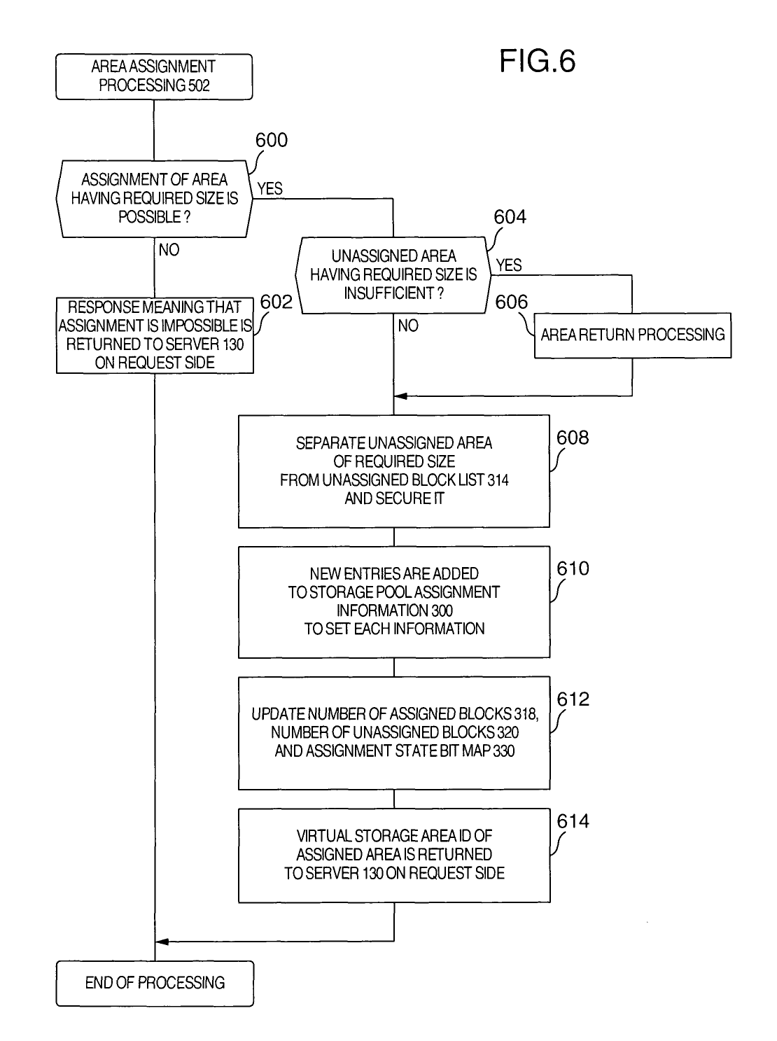

FIG. 6 is a flow chart showing an example of the area assignment processing 502.

In processing 600, the management server 100 judges whether assignment of the area (number of blocks) having a designated size can be made by the area size 408 of the area assignment instruction 400 received from the server 130 or not.

The judgment conditions include three kinds of conditions. The first condition is that the number of unassigned blocks 320 is larger than the number of blocks designated by the area size 408. The second condition is that the total of the number of unassigned blocks 320 and the number of unused blocks is larger than the number of blocks designated by the area size 408. The third condition is that the total of the number of unassigned blocks 320, the number of unused blocks and the number of blocks in which low-priority data is stored is larger than the number of blocks designated by the area size 408. When at least one of the three conditions is satisfied, the management server 100 judges that the assignment is possible and the management server 100 executes processing 604. When all of the three conditions are not satisfied, the management server 100 judges that the assignment is impossible and after processing 602 is executed, the area assignment processing 502 is ended.

In processing 602, the management server 100 returns a response meaning that the assignment is impossible to the server 130 on request side.

In processing 604, the management server 100 judges whether an unassigned area having the size designated by the area size 408 is insufficient or not.

The judgment condition is whether the number of unassigned blocks 320 is larger than the number of blocks designated by the area size 408 or not. When the number of unassigned blocks 320 is smaller than the number of blocks designated by the area size 408, area return processing 606 is executed and then processing 608 is executed. When it is larger, processing 608 is executed.

In processing 608, the management server 100 separates unassigned blocks corresponding to the number of blocks designated by the area size 408 from the unassigned block list 314 to be secured as an area to be assigned.

In processing 610, the management server 100 adds new entries to the storage pool assignment information 300 to set any ID to the virtual storage area ID 301, an ID indicating the server 130 on request side to the server ID 302, an ID indicating the process on the server 130 on request side to the process ID 304, the block numbers of the assigned area to the storage pool block number 306, the number of blocks of the assigned area to the number of assignment blocks 307, 0 to the number of blocks being in use 308, 0 to the number of high-priority data blocks 310 and 0 to the total billing amount 312.

In processing 612, the management server 100 adds the number of blocks of the area assigned this time to the number of assigned blocks 318 and subtracts the number of blocks of the area assigned this time from the number of unassigned blocks 320. Further, each bit of the assignment state bit map 330 corresponding to the blocks of the area assigned this time is set to “1”.

In processing 614, the management server returns the virtual storage area ID 301 of the assigned area to the server 130 on request side and ends the area assignment processing 502.

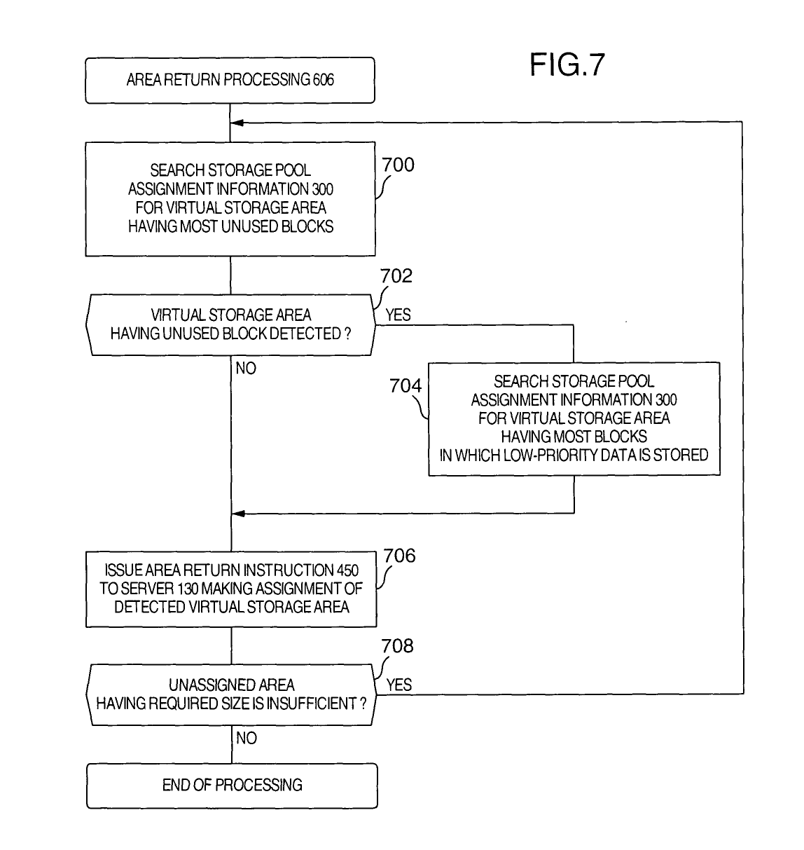

FIG. 7 is a flow chart showing an example of the area return processing 606.

In processing 700, the management server searches the storage pool assignment information 300 for a virtual storage area having the most unused blocks. The number of unused blocks is obtained by subtracting the number of blocks being in use 308 from the number of assignment blocks 307.

In processing 702, when the virtual storage area having the unused blocks is not detected in processing 700, the management server 100 executes processing 704 and when it is detected, the management server 100 executes processing 706.

In processing 704, the management server 100 searches the storage pool assignment information 300 for a virtual storage area having the most blocks in which low-priority data is stored.

In processing 706, the management server 100 issues the area return instruction 450 to the server 130 which makes assignment of the virtual storage area detected in processing 700 or 704. The application program 140 in the server 130 which has received the area return instruction 450 issues a release instruction of the area designated by the virtual storage area ID 458 and the virtual block number 460 to the management server 100.

In processing 708, the management server 100 judges whether the unassigned area having the size designated by the area size 408 is insufficient. The judgment condition in processing 708 is the same as the processing 604. When the number of unassigned blocks is smaller than the number of blocks designated by the area size 408, the processing is executed from processing 700 again and when it is larger, the area return processing 606 is ended.

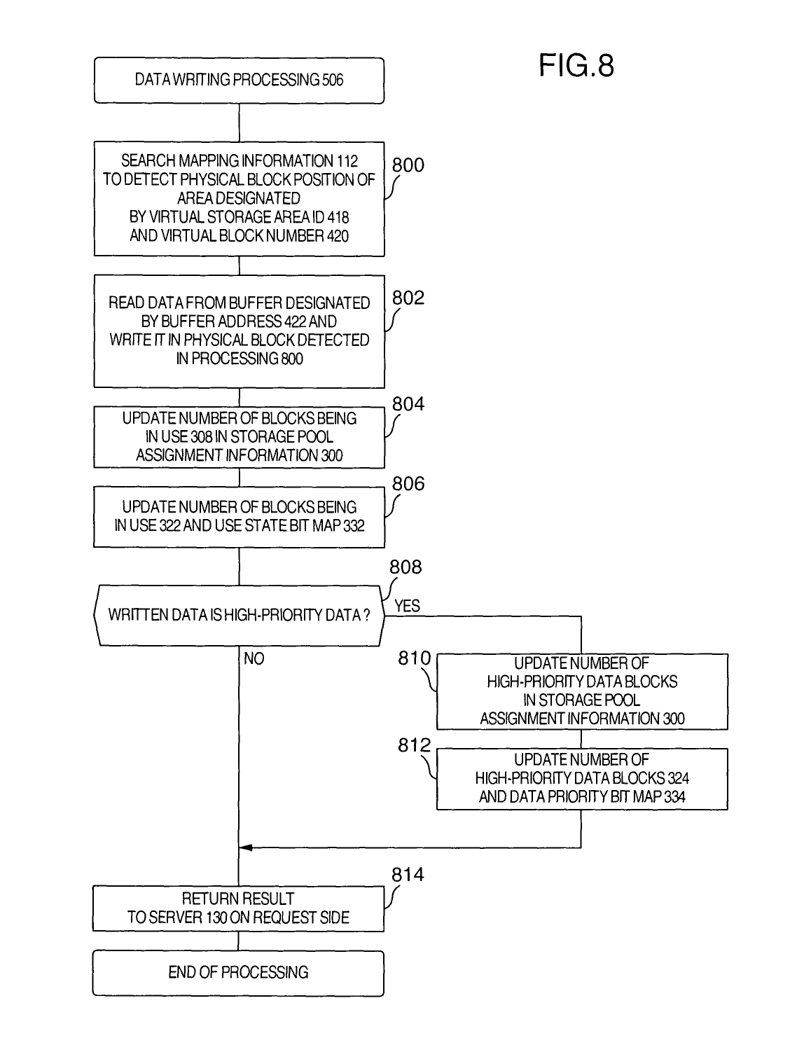

FIG. 8 is a flow chart showing an example of the data writing processing 506.

In processing 800, the management server 100 detects a storage pool block of the designated area from the virtual storage area ID 418 and the virtual block number420 in the data write instruction 410 received from the server 130 and searches the mapping information 112 on the basis of the detected storage pool block to be converted into a corresponding physical block position. The physical block position is combined information of the storage apparatus ID 202, the physical block position 204 and the physical block number 206 for specifying the physical block.

In processing 802, the management server 100 reads out data from the buffer of the server 130 on request side designated by the buffer address 422 in the data write instruction 410 and writes it in the physical block position detected in processing 800.

In processing 804, the management server 100 detects the entry of the storage pool assignment information 300 having the same ID as the virtual storage area ID 418 in the data write instruction 410 and adds the number of blocks in which data has been written this time to the number of blocks being in use 308 of the entry.

In processing 806, the management server 100 adds the number of blocks in which data has been written this time to the number of blocks being in use 322. Further, each bit of the use state bit map 332 corresponding to the blocks in which data has been written this time is set to “1”.

In processing 808, the management server 100 judges the priority of the written data from the data priority 424 in the data write instruction 410. When the written data is high-priority data, processing 810 is executed and when it is low-priority data, processing 814 is executed.

In processing 810, the management server 100 adds the number of blocks in which data has been written this time to the number of high-priority data blocks 310 of the entry of the storage pool assignment information 300 detected in processing 804.

In processing 812, the management server 100 adds the number of blocks in which data has been written this time to the number of high-priority data blocks 324. Further, each bit of the data priority bit map 334 corresponding to the blocks in which data has been written this time is set to “1”.

In processing 814, the management server 100 returns a result of processing to the server 130 on request side and ends the data writing processing 506.

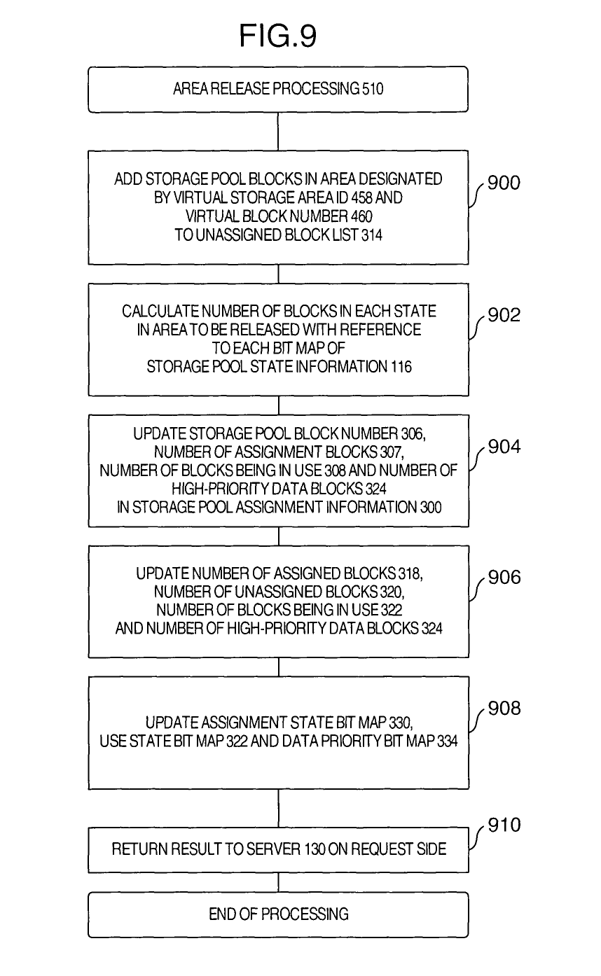

FIG. 9 is a flow chart showing an example of the area release processing 510.

In processing 900, the management server 100 adds the block numbers of the storage pool blocks designated by the virtual storage area ID 438 and the virtual block number 440 in the area release instruction 430 received from the server 130 to the unassigned block list 314.

In processing 902, the management server 100 refers to each bit map of the storage pool state information 116 to count the blocks in each state in the area to be released.

In processing 904, the management server 100 updates the entry of the storage pool assignment information 300 to which the area to be released belongs on the basis of the result in the processing 802 as follows. The storage pool block numbers of the area to be released are deleted from the storage pool block number 306. The number of blocks of the area to be released is subtracted from the number of assignment blocks 307. The number of blocks being in use in the area to be released is subtracted from the number of blocks being in use 308. The number of blocks in which high-priority data is stored in the area to be released is subtracted from the number of high-priority data blocks 310.

In processing 906, the management server 100 updates the number of assigned blocks 318, the number of unassigned blocks 320, the number of blocks being in use 322 and the number of high-priority data blocks 324 on the basis of the result in processing 902 as follows. The number of blocks in the area to be released is subtracted from the number of assigned blocks 318 and is added to the number of unassigned blocks 320. The number of blocks being in use in the area to be released is subtracted from the number of blocks being in use 322. The number of blocks in which high-priority data is stored in the area to be released is subtracted from the number of high-priority data blocks 324.

In processing 908, the management server 100 sets each bit of the assignment state bit map 330, the use state bit map 322 and the data priority bit map 334 corresponding to the blocks in the area to be released to “0”.

In processing 910, the management server 100 returns a result of processing to the server 130 on request side and ends the area release processing 510.

FIG. 10 is a flow chart showing an example of billing processing 514.

In processing 920, the management server 100 makes billing for each entry (virtual storage area) of the storage pool assignment information 300. In the billing method, the number of high-priority data blocks 310 of the entry for billing is multiplied by the billing amount of high-priority data 326 and its product is added to the total billing amount 312 of the same entry. Further, the number of high-priority data blocks 310 is subtracted from the number of blocks being in use 308 to calculate the number of low-priority data blocks and the calculated value is multiplied by a billing amount of low-priority data to be also added to the total billing amount 312.

In processing 922, the management server 100 judges whether the processing 920 is executed for all entries in the storage pool assignment information 300. When the processing 920 is executed for all entries, the billing processing 514 is ended. When the processing 920 is not yet executed for all entries, the processing 920 is executed for next entry.

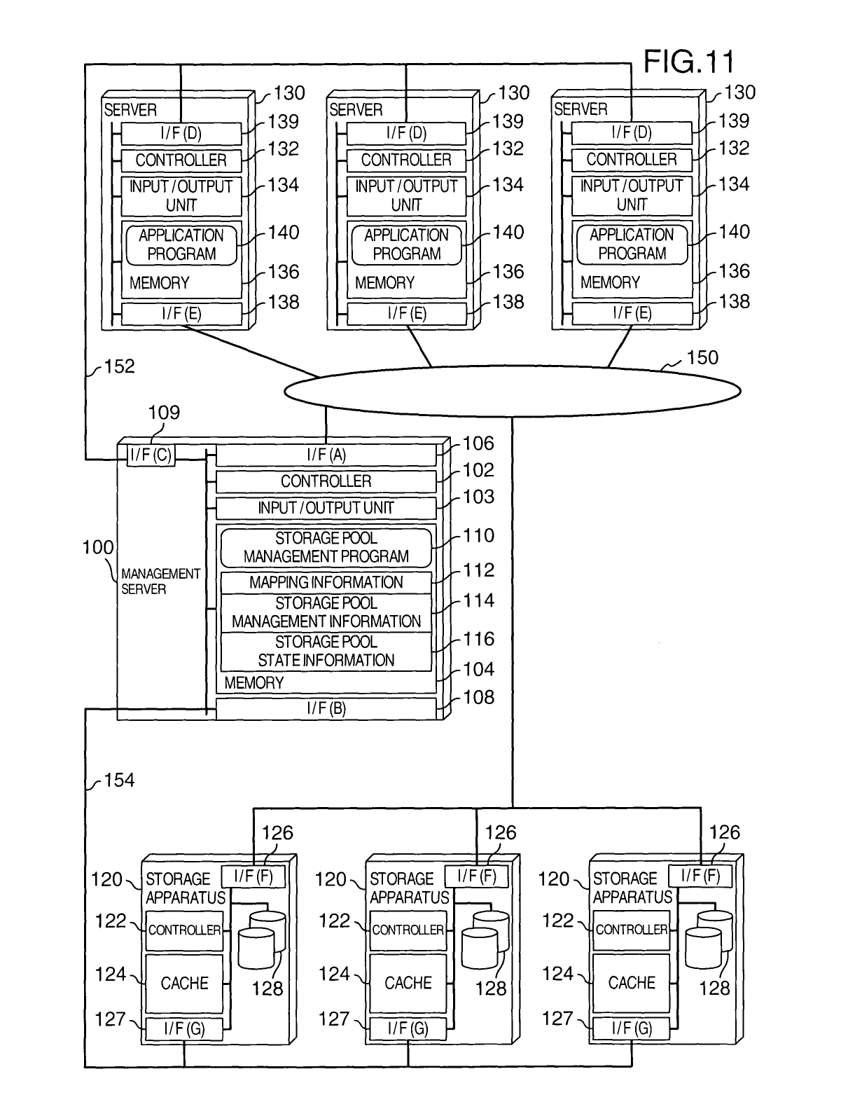

FIG. 11 is a block diagram illustrating another embodiment of a computer system to which the present invention is applied.

In the computer system of FIG. 11, the serves 130 are connected through the network 152, the management server 100 and an network 154 to the storage apparatuses 120 and further connected even through the network 150 to the storage apparatuses 120.

The server 130 includes the controller 132, the input/output unit 134, the memory 136, the interface (E) 138 for connecting the network 150 and an interface (D) 139 for connecting the network 152.

The management server 130 includes the controller 102, the input/output unit 103, the memory 104, the interface (A) 106 for connecting the network 150, an interface (C) 109 for connecting the network 152 and the interface (B) 108 for connecting the network 154.

The storage apparatus 120 includes the controller (control processor) 122, the cache 124, the interface (F) 126 for connecting the network 152, an interface (G) 127 for connecting the network 154 and the disk unit 128.

Three servers 130 and three storage apparatuses 120 are shown in FIG. 11, although the numbers thereof are not limited thereto and may be any number.

In the computer system of FIG. 11, when the management server 100 receives an access request to the storage apparatus 120 from the server 130 through the network 152, the management server returns position information of the storage area in which actual data is stored to the server. The server 130 accesses to the storage area of the storage apparatus 120 through the network 150 in accordance with the received information. Exchanges of the instructions shown in FIG. 4 are made between the server 130 and the management server 100 through the network 152. Other operations are the same as the embodiment of FIG. 1 to which the present invention is applied.

According to the embodiments described above, even when the unassigned area is insufficient, the storage area can be assigned to the server 130 issuing the assignment request without waiting until the storage capacity is increased by increase of a new storage apparatus in the SAN or the like.

According to the present invention, even when the assignment request of storage areas exceeding the unassigned areas is issued by the server, the storage areas can be assigned to the server to thereby utilize the storage areas in the storage pool effectively.

It should be further understood by those skilled in the art that although the foregoing description has been made on embodiments of the invention, the invention is not limited thereto and various changes and modifications may be made without departing from the spirit of the invention and the scope of the appended claims.

1. A management server connected to a plurality of servers to manage storage areas included in storage apparatuses as virtual storage areas; wherein
said storage apparatuses are shared by said plurality of servers; and
said storage apparatuses includes assignment areas which are storage areas assigned to at least one of said plurality of servers;
said management server being responsive to an area assignment instruction of storage areas exceeding unassigned areas received from one of said plurality of servers to release at least part of said assignment areas of other servers as unassigned areas and assign the areas to one of said plurality of servers.

2. A management server according to claim 1, wherein
said assignment areas of said storage apparatuses include used areas and unused areas; and
said management server includes information for identifying said used areas and said unused areas of said assignment areas;
said management server being responsive to an area assignment instruction of storage areas exceeding the unassigned areas received from one of said plurality of servers to release at least part of said unused areas of said assignment areas of other servers on the basis of said identification information as unassigned areas and assign the areas to one of said servers.

3. A management server according to claim 1, wherein
data stored in said assignment areas of said storage apparatuses includes high-priority data having high priority and low-priority data having low priority; and
said management server judges whether data to be written in said storage apparatuses is the high-priority data or the low-priority data on the basis of a write request of data from said server and keeps judgment result and position information of storage areas in which said data is written;
said management server being responsive to an area assignment instruction of storage areas exceeding the unassigned areas received from one of said plurality of servers to release at least part of areas in which the low-priority data is stored, of the assignment areas of other servers as unassigned areas and assign the areas to one of said plurality of servers.

4. A management server according to claim 2, wherein
data stored in the used areas in said assignment areas of said storage apparatuses includes high-priority data having high priority and low-priority data having low priority; and
said management server judges whether data to be written in said storage apparatuses is the high-priority data or the low-priority data on the basis of a write request of data from said server and keeps judgment result and position information of storage areas in which said data is written;
said management server being responsive to an area assignment instruction of storage areas exceeding the unassigned areas received from one of said plurality of servers to release at least part of unused areas and at least part of areas in which the low-priority data is stored, of the assignment areas of other servers as unassigned areas and assign the areas to one of said plurality of servers.

5. A management server according to claim 1, wherein
said management server makes billing processing for each of said plurality of servers utilizing said storage apparatuses at predetermined intervals.

6. A management server according to claim 5, wherein
said management server establishes different billing amounts depending on the cases where the low-priority data is stored and the high-priority data is stored.

7. A storage apparatus system comprising:
a storage apparatuses; and
a management server connected to a plurality of servers and said storage apparatuses;
said management server managing storage areas of said storage apparatuses as virtual storage areas;
said storage apparatuses being shared by said plurality of servers;
said storage apparatuses including assignment areas which are storage areas assigned to at least one of said plurality of servers;
said management serve being responsive to an area assignment instruction of storage areas exceeding unassigned areas received from one of said plurality of servers to release at least one of assignment areas of other servers as unassigned area and assign the areas to one of said plurality of servers.

8. A storage apparatus system according to claim 7, wherein
said assignment areas of said storage apparatuses include used areas and unused areas; and
said management server includes information for identifying said used areas and said unused areas of said assignment areas;
said management server being responsive to an area assignment instruction of storage areas exceeding the unassigned areas received from one of said plurality of servers to release at least part of said unused areas of other servers on the basis of said identification information as unassigned areas and assign the areas to one of said servers.

9. A storage apparatus system according to claim 7, wherein
data stored in said assignment areas of said storage apparatuses includes high-priority data having high priority and low-priority data having low priority; and
said management server judges whether data to be written in said storage apparatuses is the high-priority data or the low-priority data on the basis of a write request of data from said server and keeps judgment result and position information of storage areas in which said data is written;
said management server being responsive to an area assignment instruction of storage areas exceeding the unassigned areas received from one of said plurality of servers to release at least part of areas in which the low-priority data is stored, of the assignment areas of other servers as unassigned areas and assign the areas to one of said plurality of servers.

10. A storage apparatus system according to claim 8, wherein
data stored in said used areas of said storage apparatuses includes high-priority data having high priority and low-priority data having low priority; and
said management server judges whether data to be written in said storage apparatuses is the high-priority data or the low-priority data on the basis of a write request of data from said server and keeps judgment result and position information of storage areas in which said data is written;
said management server being responsive to an area assignment instruction of storage areas exceeding the unassigned areas received from one of said plurality of servers to release at least part of said unused areas and at least part of areas in which the low-priority data is stored, of the assignment areas of other servers as unassigned areas and assign the areas to one of said plurality of servers.

11. A storage apparatus system according to claim 7, wherein
said management server makes billing processing for each of said plurality of servers utilizing said storage apparatuses at predetermined intervals.

12. A storage apparatus system according to claim 11, wherein
said management server establishes different billing amounts depending on the cases where low-priority data is stored and high-priority data is stored.

13. A computer program product for a management server which manages storage areas included in storage apparatuses as virtual storage areas, wherein
said management server is connected to a plurality of servers; and
said storage apparatuses are shared by said plurality of servers through said management server and include assignment areas which are storage areas assigned to at least one of said plurality of servers; and
said computer program product comprising:
a code for being responsive to an area assignment instruction of storage areas exceeding unassigned areas received from one of said plurality of servers to release at least part of assignment areas of other servers as unassigned areas and assign the area to one of said plurality of servers; and
a computer readable storage medium for storing said code.

14. A computer program product according to claim 13, wherein
said assignment areas of said storage apparatuses include used areas and unused areas; and
said computer program product further comprising:
a code for information for identifying said used areas and said unused areas of said assignment areas;
said code for releasing at least part of assignment areas of other servers as unassigned areas including a code for being responsive to the area assignment instruction of storage areas exceeding unassigned areas received from one of said plurality of servers to release at least part of said unused areas of other servers as unassigned areas on the basis of said identification information.

15. A computer program product according to claim 13, wherein
data stored in said assignment areas of said storage apparatuses include high-priority data having high priority and low-priority data having low priority; and
said computer program product further comprising:
a code for judging on the basis of a write request of data from said server whether data to be written in said storage apparatuses is said high-priority data or said low-priority data; and
a code for information indicative of judgment result and position of storage areas in which said data is written;
said code for releasing at least part of assignment areas of other servers as unassigned areas including a code for being responsive to the area assignment instruction of storage areas exceeding the unassigned areas received from one of said plurality of servers to release at least part of areas in which said low-priority data is stored, of the assignment areas of other servers as unassigned areas.

16. A computer program product according to claim 14, wherein
data stored in said used areas of said storage apparatuses include high-priority data having high priority and low-priority data having low priority; and
said computer program product further comprising:
a code for judging on the basis of a write request of data from said server whether data to be written in said storage apparatuses is said high-priority data or said low-priority data; and
a code for information indicative of judgment result and position of storage areas in which said data is written;
said code for releasing at least part of unused areas of assignment areas of other servers as unassigned areas including a code for being responsive to the area assignment instruction of storage areas exceeding the unassigned areas received from one of said plurality of servers to release at least part of said unused areas and at least part of areas in which said low-priority data is stored, of the assignment areas of other servers as unassigned areas.

17. A computer program product according to claim 13, further comprising:
a code for causing said management server to execute billing processing for each of said plurality of servers utilizing said storage apparatuses at predetermined intervals.

18. A computer program product according to claim 17, further comprising:
a code for establishing different billing amounts depending on the cases where low-priority data is stored and high-priority data is stored.
